(19) United States
(12) Patent Application Publication
(10) Pub. No.: US 2026/0249800 A1
(43) Pub. Date: Aug. 27, 2026

(54) VEHICLE CONTROL APPARATUS

(71) Applicant: TOYOTA JIDOSHA KABUSHIKI KAISHA, Aichi (JP)

(72) Inventor: Tomoki SOMIYA, Okazaki-shi (JP)

(21) Appl. No.: 19/538,990

(22) Filed: Feb. 13, 2026

(30) Foreign Application Priority Data
Feb. 21, 2025 (JP) 2025-026329

(51) Int. Cl. B60R 21/0134; B60R 21/0136; B60W 10/06; B60W 10/18; B60W 30/09

(52) U.S. Cl. CPC B60R 21/0134; B60R 21/0136; B60W 10/06; B60W 10/18; B60W 30/09

(57) ABSTRACT

A vehicle control apparatus executes vehicle control to change a traveling state of the vehicle according to a control pattern selected from among a plurality of control patterns so as to reduce a collision risk, when the collision risk is equal to or greater than a threshold risk. The vehicle control apparatus estimates, for each of the control patterns, a first occupant damage representing damage to the occupant caused by a change in the traveling state during the vehicle control, a second occupant damage representing damage to the occupant at a collision time, and an object damage representing damage to the collision object at the collision time. The vehicle control apparatus executes the vehicle control according to the control pattern in which a total damage, acquired based on the first occupant damage, the second occupant damage, and the object damage, is minimized.

### TECHNICAL FIELD

The present disclosure relates to a vehicle control apparatus that performs a vehicle control for changing a traveling state of a vehicle in order to reduce a collision risk when the collision risk is equal to or greater than a threshold risk.

### BACKGROUND

Conventionally, a vehicle control apparatus that performs a vehicle control when a collision risk with an object is equal to or greater than a threshold risk has been known. For example, a vehicle control apparatus described in Patent Document 1 (hereinafter referred to as “the conventional apparatus”) estimates, when a collision with the object is inevitable, collision damage representing damage to an occupant caused by the collision based on an amount of cabin deformation and a boarding state of the occupant in the vehicle. The conventional apparatus then performs the vehicle control based on a vehicle control amount for minimizing the collision damage.
Patent Document 1: Japanese Patent Application Laid-open No. 2008-024108

### SUMMARY

When the vehicle collides with an object (hereinafter referred to as “a collision object”), damage occurs not only to the occupant of the vehicle but also to the collision object. Furthermore, the damage to the occupant may occur not only due to the collision damage to the occupant caused by the collision, but also due to a change in a traveling state of the vehicle caused by execution of the vehicle control. Since the conventional apparatus does not take into consideration the damage to the collision object and the damage to the occupant during the execution of the vehicle control, the conventional apparatus may not be able to perform the vehicle control appropriately.

The present disclosure is made to address the above problem. That is, one of the objects of the present invention is to provide a vehicle control apparatus capable of increasing a possibility of performing the vehicle control appropriately in consideration of the damage to the occupant caused by the collision, the damage to the occupant during the execution of the vehicle control, and the damage to the collision object caused by the collision.

A vehicle control apparatus according to the present disclosure (hereinafter referred to as “the present apparatus”), when a collision risk, which represents a risk of a vehicle colliding with an object, is equal to or greater than a threshold risk (step 420: “Yes”), performs vehicle control to change a traveling state of the vehicle according to a control pattern selected from among a plurality of control patterns so as to reduce the collision risk (step 450).

The present apparatus is configured to:
estimate, for each of the control patterns,
   a first occupant damage (D1) representing damage to an occupant caused by a change in the traveling state during a vehicle control period from when the vehicle control is executed according to the control pattern until the vehicle collides with a collision object (step 525),
   a second occupant damage (D2) representing damage to the occupant at a collision time when the vehicle collides with the collision object as a result of executing the vehicle control according to the control pattern (step 530), and
   an object damage (D3) representing damage to the collision object at the collision time (step 535); and
execute the vehicle control according to the control pattern that minimizes a total damage (Dt) acquired based on the first occupant damage, the second occupant damage, and the object damage (step 440, step 450).

According to the present apparatus, the vehicle control is performed according to the control pattern that minimizes the total damage acquired based on the first occupant damage, the second occupant damage, and the object damage. Accordingly, the present apparatus can perform the vehicle control appropriately based on the first occupant damage, the second occupant damage, and the object damage.

### BRIEF DESCRIPTION OF THE DRAWINGS

FIG. 1 is a schematic system configuration diagram of a vehicle control apparatus according to an embodiment of the present disclosure.

FIG. 2 is an explanatory diagram illustrating a deceleration control pattern.

FIG. 3 is an explanatory diagram illustrating a steering control pattern.

FIG. 4 is a flowchart illustrating a vehicle control routine executed by a CPU of an ECU shown in FIG. 1.

FIG. 5 is a flowchart illustrating a total damage estimation subroutine executed by the CPU of the ECU shown in FIG. 1.

FIG. 6 is an explanatory diagram of control occupant damage, collision occupant damage, and object damage for each combination of control patterns.

### DETAILED DESCRIPTION

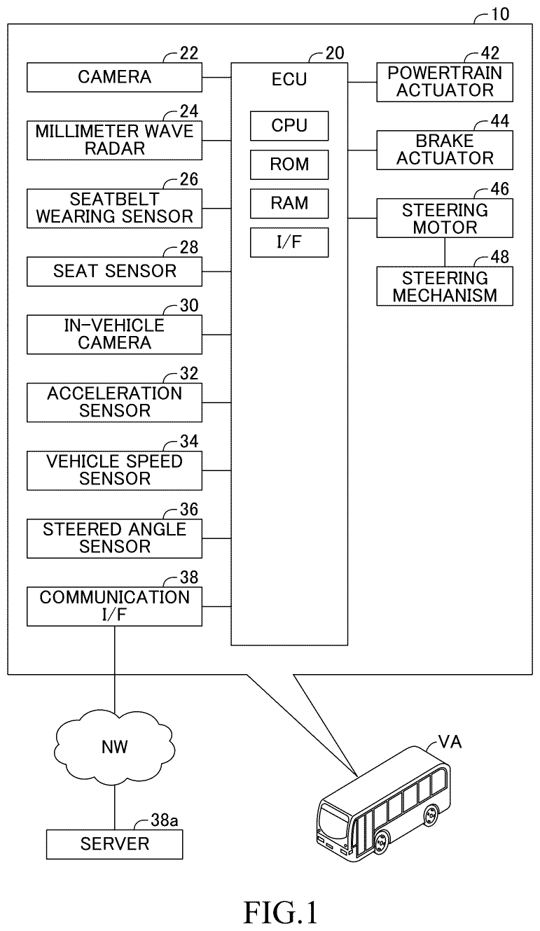

A vehicle control apparatus 10 according to an embodiment of the present disclosure (hereinafter, referred to as “the present apparatus 10”) is applied to a vehicle VA and comprises components shown in FIG. 1. In the present specification, an “ECU 20” is an electronic control unit having a microcomputer as a main component. The ECU 20 is also referred to as a control unit, a controller and a computer. The microcomputer includes a CPU (processor), a ROM, a RAM and an interface (I/F), etc. Functions realized by the ECU 20 may be realized by multiple ECUs.

A camera 22 acquires forward image data by capturing an area in front of the vehicle VA. The ECU 20 obtains the forward image data from the camera 22. A millimeter-wave radar 24 detects an object present in front of the vehicle VA and acquires object data related to the object. The ECU 20 obtains the forward image data and the object data from the front camera 22 and the millimeter-wave radar 24, respectively, and specifies a position of the object relative to the vehicle VA and a relative speed of the object with respect to the vehicle VA based on the forward image data and the object data.

A seatbelt wearing sensor 26 detects a wearing state indicating whether an occupant of the vehicle VA is wearing a seatbelt (occupant restraint device). A seat sensor 28 detects a sitting state indicating whether the occupant is seated on a seat of the vehicle VA. The ECU 20 obtains detection values representing the states detected by these sensors 26 and 28. An in-vehicle camera 30 acquires in-vehicle image data by capturing a passenger compartment of the vehicle VA. The ECU 20 obtains the in-vehicle image data from the in-vehicle camera 30 and specifies an occupant's posture, a gripping state indicating whether the occupant is gripping a structure in the passenger compartment (such as a handrail or a strap), the occupant's position in the passenger compartment, and the congestion state in the passenger compartment.

An acceleration sensor 32 measures a longitudinal acceleration Gx of the vehicle VA and a lateral acceleration Gy of the vehicle VA. The acceleration Gx in the forward direction of the vehicle VA is a positive value, and the acceleration Gx in the rearward direction of the vehicle VA is a negative value. The acceleration Gx having a negative value may be referred to as “a deceleration.” A vehicle speed sensor 34 measures a vehicle speed Vs representing a speed of the vehicle VA. A steered angle sensor 36 measures a steered angle θ of steered wheels. The ECU 20 obtains measured values from the sensors 32 to 36.

A communication interface (I/F) 38 communicates with a server 38a via a network NW.

A powertrain actuator 42 changes a driving force generated by a drive unit of the vehicle VA (for example, an internal combustion engine and/or an electric motor). A brake actuator 44 changes a braking force applied to the vehicle VA. A steering motor 46 is incorporated in a steering mechanism 48. The steering mechanism 48 is a mechanism for steering the steered wheels according to a steering operation of a steering wheel (not shown) by the driver. Furthermore, the steering motor 46 applies an automatic steering torque for changing the steered angle θ (a traveling direction of the vehicle VA) of the steered wheels in accordance with an instruction from the ECU 20.

### Overview of Operation

The ECU 20 of the present apparatus 10 performs a vehicle control for changing a traveling state of the vehicle VA in order to reduce a collision risk representing a possibility that the vehicle VA collides with the object when the collision risk is equal to or greater than a threshold risk. Such vehicle control is a type of autonomous driving for assisting the driver's driving.

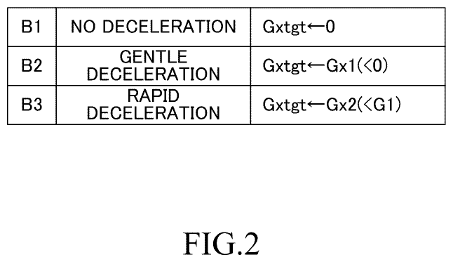

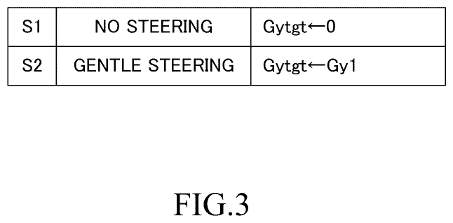

Specifically, the ECU 20 selects one control pattern each from a deceleration control pattern shown in FIG. 2 and a steering control pattern shown in FIG. 3, and performs the vehicle control according to the selected control patterns. A plurality of deceleration control patterns with different decelerations set as target acceleration Gxtgt are prepared in advance. Similarly, a plurality of steering control patterns with different lateral accelerations set as target lateral acceleration Gytgt are prepared in advance.

The ECU 20 estimates control occupant damage D1, collision occupant damage D2, and object damage D3 for all combinations of the deceleration control patterns and the steering control patterns, and acquires total damage Dt based on the control occupant damage D1, the collision occupant damage D2, and the object damage D3. The ECU 20 performs the vehicle control according to the combination of control patterns that minimizes the total damage Dt.

The control occupant damage D1 represents damage to the occupant caused by a change in the vehicle's traveling state while the vehicle control is being performed according to the above combination of the control patterns. The control occupant damage D1 may also be referred to as “first occupant damage.”

The collision occupant damage D2 represents damage to the occupant caused by the collision between the vehicle VA and a collision object while the vehicle control is being performed according to the above combination of the control patterns. The collision object represents an object with which the vehicle VA collides. The collision object may be different from the object whose collision risk was equal to or greater than the threshold risk at the start of the vehicle control, since the steering control performed as the vehicle control is intended to change the traveling direction of the vehicle VA. The collision occupant damage D2 may also be referred to as “second occupant damage.”

The object damage D3 represents damage to the collision object caused by the collision between the vehicle VA and the collision object.

As a result, the present apparatus 10 can increase the possibility of appropriately performing the vehicle control by considering not only the collision occupant damage D2 but also the control occupant damage D1 and the object damage D3.

### Deceleration Control Patterns

As shown in FIG. 2, three deceleration control patterns B1 to B3 are prepared in advance. In deceleration control pattern B1, the target acceleration Gxtgt is set to “0.” That is, the deceleration control pattern B1 is a control pattern that does not decelerate the vehicle VA. In deceleration control pattern B2, the target acceleration Gxtgt is set to Gx1, which is a negative value. That is, the deceleration control pattern B2 is a control pattern that gently decelerates the vehicle VA. In deceleration control pattern B3, the target acceleration Gxtgt is set to Gx2, which is a negative value smaller than Gx1. That is, the deceleration control pattern B3 is a control pattern that decelerates the vehicle VA rapidly.

### Steering Control Patterns

As shown in FIG. 3, two steering control patterns S1 and S2 are prepared in advance. In steering control pattern S1, the target lateral acceleration Gytgt is set to “0.” That is, the steering control pattern S1 is a control pattern that does not change the traveling direction of the vehicle VA. In steering control pattern S2, the target lateral acceleration Gytgt is set to Gy1. That is, the steering control pattern S2 is a control pattern that gently changes the traveling direction of the vehicle VA.

### Specific Operation

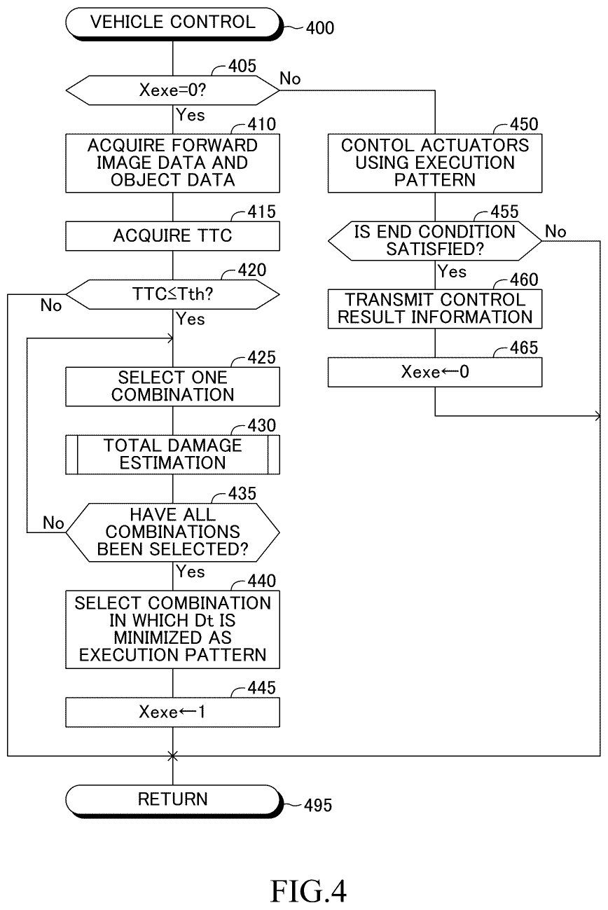

The CPU of the ECU 20 executes a routine shown in a flowchart of FIG. 4 each time a predetermined time has elapsed.

### Vehicle Control Routine

When an appropriate timing comes, the CPU starts a process from step 400 in FIG. 4. At step 405, the CPU determines whether or not an execution flag Xexe is “0”. The execution flag Xexe is set to “1” when the vehicle control is performed, and set to “0” when vehicle control is not performed. The execution flag Xexe is set to “0” in an initialization routine. The initialization routine is executed by the CPU when an ignition key switch (not shown) of the vehicle VA is switched from an off position to an on position.

If the execution flag Xexe is “0”, the CPU makes a “Yes” determination at step 405 and executes steps 410 to 420.

Step 410: The CPU obtains the forward image data and the object data.

Step 415: The CPU recognizes the object based on the forward image data and the object data, and acquires a TTC representing the time until the object collides with the vehicle VA. TTC stands for “Time To Collision.” TTC is an index value representing the collision risk of the object. The smaller the TTC, the higher the collision risk. The CPU acquires the TTC by dividing the distance between the vehicle VA and the object by the relative speed of the object with respect to the vehicle VA.

If the TTC is greater than a threshold time Tth, that is, if the collision risk is less than the threshold risk, the CPU makes a “No” determination at step 420, and the process proceeds to step 495. At step 495, the CPU terminates this routine tentatively.

If the TTC is equal to or less than the threshold time Tth, that is, if the collision risk is equal to or greater than the threshold risk, the CPU makes a “Yes” determination at step 420 and executes steps 425 to 435.
Step 425: The CPU selects one combination of the deceleration control pattern and the steering control pattern.

Step 430: The CPU executes a total damage estimation subroutine for estimating the total damage Dt that is caused when the vehicle control is performed according to the combination of control patterns selected at step 425. Details of the total damage estimation subroutine will be described later.

Step 435: The CPU determines whether or not all combinations have been selected.

If all combinations have not been selected, the CPU makes a “No” determination at step 435. In this case, the process returns to step 425, and the CPU selects another combination of the deceleration control pattern and the steering control pattern that has not yet been selected.

On the other hand, if all combinations have been selected, the CPU makes a “Yes” determination at step 435 and executes steps 440 and 445.

Step 440: The CPU selects, as an execution pattern, the combination in which the total damage Dt is minimized.

Step 445: The CPU sets the execution flag Xexe to “1.”

Thereafter, the process proceeds to step 495.

If the execution flag Xexe is “1” when the process proceeds to step 405, the CPU makes a “No” determination at step 405 and executes steps 450 and 455.

Step 450: The CPU controls the powertrain actuator 42, the brake actuator 44, and the steering motor 46 based on the execution pattern. Specifically, the CPU controls the powertrain actuator 42 and the brake actuator 44 such that the longitudinal acceleration Gx of the vehicle VA matches the target longitudinal acceleration Gxtgt defined by the deceleration control pattern. The CPU also controls the steering motor 46 such that the lateral acceleration Gy of the vehicle VA matches the target lateral acceleration Gytgt defined by the steering control pattern.

Step 455: The CPU determines whether or not an end condition for the vehicle control is satisfied. For example, the CPU determines that the end condition is satisfied when the collision risk of the object no longer exists or when the vehicle VA has stopped.

If the end condition is not satisfied, the CPU makes a “No” determination at step 455, and the process proceeds to step 495. If the end condition is satisfied, the CPU makes a “Yes” determination at step 455, and executes steps 460 and 465.

Step 460: The CPU transmits control result information to the server 38a. The acceleration generated during the vehicle control, the change in the occupant's posture during the vehicle control, the actual collision pattern, the change in the occupant's posture at the time of collision, and the damage to the actual collision object are specified based on the control result information.

It should be noted that, if the vehicle VA does not collide with the object, it is sufficient that the acceleration generated during the vehicle control and the change in the occupant's posture during the vehicle control can be specified based on the control result information.

For example, the CPU can specify the change in the occupant's posture during the vehicle control and at the time of collision based on the in-cabin image data acquired during the vehicle control and at the time of collision. The CPU can specify the collision pattern and the damage to the collision object based on the forward image data acquired at the time of the collision.

Step 465: The CPU sets the execution flag Xexe to “0.”

Thereafter, the process proceeds to step 495.

### Total Damage Estimation Subroutine

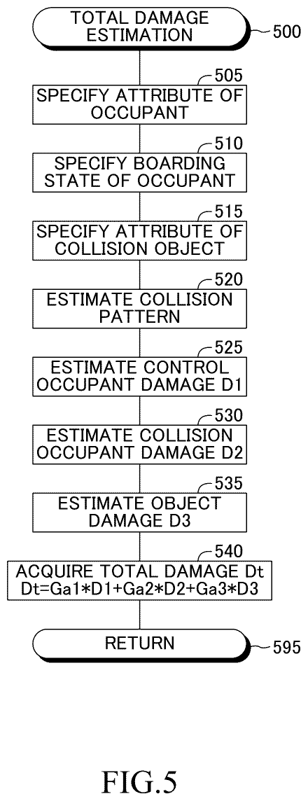

When the process proceeds to step 430, the CPU starts a process from step 500 in FIG. 5 and executes steps 505 to 540.

Step 505: The CPU specifies an attribute of the occupant.

The attribute of the occupant includes the occupant's age and gender. The CPU specifies the occupant's age and gender based on information registered in the occupant's smartphone, transportation IC card, or the like. The CPU may alternatively specify the occupant's age and gender based on the in-vehicle image data.

Step 510: The CPU specifies a boarding state of the occupant.

The boarding state of the occupant includes the occupant's posture, the occupant's gripping state of the structure, the occupant's seatbelt wearing state, the occupant's position in the passenger compartment, and the congestion state in the passenger compartment. The CPU specifies the occupant's posture, the occupant's gripping state of the structure, the occupant's position in the passenger compartment, and the congestion state in the passenger compartment based on the in-vehicle image data. The CPU specifies the occupant's seatbelt wearing state based on the detection value of the seatbelt wearing sensor 26. The CPU may alternatively specify the occupant's position in the passenger compartment based on the detection value of the seat sensor 28.

Step 515: The CPU specifies an attribute of the collision object.

The attribute of the collision object is a type of the collision object. For example, the type of the collision object indicates whether the collision object is a vehicle, a pedestrian, a guardrail, a wall, or the like. The CPU specifies the type of the collision object based on the forward image data.

Step 520: The CPU estimates the collision pattern between the vehicle VA and the collision object.

The collision pattern includes a collision speed, which represents the relative speed of the collision object with respect to the vehicle VA at the time of the collision, and a collision position on the vehicle body of the vehicle VA where the collision object collides. The CPU specifies the collision speed based on the current vehicle speed Vs, the target accelerations (Gxtgt and Gytgt) defined by the selected control patterns, and the current relative speed of the collision object. Furthermore, the CPU estimates a future traveling route of the vehicle VA based on the current vehicle speed Vs and the target accelerations (Gxtgt and Gytgt) defined by the selected control patterns, and estimates a future traveling route of the collision object based on a “history of a position of the collision object with respect to the vehicle VA.” Then, the CPU specifies the collision position on the vehicle body based on the estimated future predicted traveling route of the vehicle VA and the estimated future predicted traveling route of the collision object.

Step 525: The CPU estimates the control occupant damage D1 based on the attribute of the occupant, the boarding state of the occupant, and a control acceleration.

The control acceleration represents an acceleration generated in the vehicle VA by the vehicle control executed according to the selected combination. The CPU specifies the control acceleration based on the current vehicle speed Vs and the target accelerations (Gxtgt and Gytgt) defined by the selected control patterns.

The control occupant damage D1 increases as the number of the occupants determined, based on their ages, to be infants or elderly persons increases. The control occupant damage D1 increases as the number of female occupants increases.

The control occupant damage D1 increases as the number of the occupants not seated increases. The control occupant damage D1 increases as the number of the occupants not gripping the structure increases. The control occupant damage D1increases as the number of the occupants not wearing the seatbelt increases. The control occupant damage D1 increases as the congestion in the passenger compartment increases.

Step 530: The CPU estimates the collision occupant damage D2 based on the attribute of the occupant, the boarding state of the occupant, the attribute of the collision object, and the collision pattern. The estimation of the collision occupant damage D2 based on the attribute of the occupant and the boarding state of the occupant is the same as that of the control occupant damage D1, and thus, a description thereof will be omitted. The closer the position of the occupant in the passenger compartment is to the collision position, the greater the collision occupant damage D2 becomes.

Step 535: The CPU estimates the object damage D3 based on the attribute of the collision object and the collision pattern.

Step 540: The CPU estimates the total damage Dt by applying the control occupant damage D1, the collision occupant damage D2, and the object damage D3 to the following equation (1).

$$Dt = Ga 1 \times D 1 + Ga 2 \times D 2 + Ga 3 \times D 3 \qquad equation ( 1 )$$

Ga1, Ga2, and Ga3 are gains set to desired values in a range of “0.0” or more and “1.0” or less. In the present embodiment, Ga1, Ga2, and Ga3 are set to “1.0.”

Thereafter, the process proceeds to step 595, the CPU terminates the present routine tentatively, and the process proceeds to step 435 shown in FIG. 4.

Accordingly, the present apparatus 10 can increase the possibility of performing the vehicle control appropriately by taking into account not only the collision occupant damage D2 but also the control occupant damage D1 and the object damage D3.

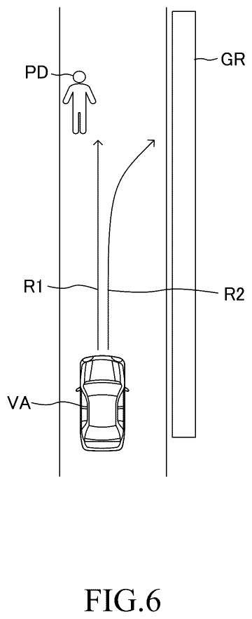

In the example shown in FIG. 6, the control occupant damage D1, the collision occupant damage D2, and the object damage D3 in each combination will be described.
(1) When a combination of the deceleration control pattern B1 and the steering control pattern S1 is selected, the vehicle VA travels straight along a route R1 without decelerating. When the vehicle VA travels straight along the route R1, the vehicle VA collides with a pedestrian PD.

Since the vehicle VA travels straight without decelerating, no acceleration is generated by the vehicle control. Therefore, the control occupant damage D1 is “0 points.” Since the vehicle VA collides with the collision object (pedestrian PD) without decelerating, the collision vehicle speed is high. Furthermore, the type of the collision object (pedestrian PD) is “pedestrian.” Therefore, the collision occupant damage D2 is “3 points,” and the object damage D3 is “10 points.” Accordingly, the total damage Dt is 13 points.
(2) When a combination of the deceleration control pattern B2 and the steering control pattern S1 is selected, since the vehicle VA decelerates gradually, the magnitude of acceleration generated by the vehicle control becomes greater than that in (1) above. Therefore, the control occupant damage D1 becomes greater than that in (1) above, namely “1 point.” Since the vehicle VA collides with the collision object after gradually decelerating, the collision vehicle speed becomes lower than that in (1) above. Furthermore, the type of the collision object is the same as in (1) above, namely “pedestrian.” Therefore, the collision occupant damage D2 becomes smaller than that in (1) above, namely “2 points,” and the object damage D3 becomes smaller than that in (1) above, namely “7 points.” Accordingly, the total damage Dt is 10 points.
(3) When a combination of the deceleration control pattern B3 and the steering control pattern S1 is selected, since the vehicle VA decelerates rapidly, the magnitude of acceleration generated by the vehicle control becomes greater than that in (2) above. Therefore, the control occupant damage D1 is “2 points.” Since the vehicle VA collides with the collision object after rapidly decelerating, the collision vehicle speed becomes lower than that in (2) above. Furthermore, the type of the collision object is the same as in (1) and (2) above, namely “pedestrian.” Therefore, the collision occupant damage D2 becomes lower than that in (2) above, namely “1 point,” and the object damage D3 becomes lower than that in (1) above, namely “5 points.” Accordingly, the total damage Dt is 8 points.
(4) When a combination of the deceleration control pattern B1 and the steering control pattern S2 is selected, the vehicle VA turns to the right along a route R2 without decelerating. When the vehicle VA travels along the route R2, the vehicle VA collides with a guardrail GR instead of the pedestrian PD. Since the vehicle VA turns to the right without decelerating, the magnitude of acceleration generated by the vehicle control becomes greater than that in (1) above. Therefore, the control occupant damage D1 is “1 point.” Since the vehicle VA collides with the collision object (guardrail GR) without decelerating, the collision vehicle speed is high. Furthermore, the type of the collision object is “guardrail.” Therefore, the collision occupant damage D2 is “6 points,” and the object damage D3 is “0 points.” Accordingly, the total damage Dt is 7 points.

The collision occupant damage D2 becomes lower when the type of the collision object is a pedestrian, and becomes higher when the type of the collision object is a vehicle, a guardrail, a wall, or the like. The object damage D3 becomes higher when the type of the collision object is the pedestrian, and becomes lower when the type of the collision object is the guardrail, the wall, or the like. In addition, when the type of the collision object is the vehicle, there is a possibility that a person is on board the vehicle, and thus, the object damage D3 becomes higher than when the type of the collision object is the guardrail, the wall, or the like.
(5) When a combination of the deceleration control pattern B2 and the steering control pattern S2 is selected, since the vehicle VA turns to the right while gradually decelerating, the magnitude of acceleration generated by the vehicle control becomes greater than that in (2) above. Therefore, the control occupant damage D1 becomes greater than that in (2) above, namely “2 points.” Since the vehicle VA collides with the collision object after gradually decelerating, the collision vehicle speed becomes lower than that in (4) above. Furthermore, the type of the collision object is the same as in (4) above, namely “guardrail.” Therefore, the collision occupant damage D2 becomes smaller than that in (4) above, namely “4 points,” and the object damage D3 is “0 points.” Accordingly, the total damage Dt is 6 points.
(6) When a combination of the deceleration control pattern B3 and the steering control pattern S2 is selected, since the vehicle VA turns to the right while decelerating rapidly, the magnitude of acceleration generated by the vehicle control becomes greater than that in (3) above. Therefore, the control occupant damage D1 is “3 points.” Since the vehicle VA collides with the collision object after rapidly decelerating, the collision vehicle speed becomes lower than that in (5) above. Furthermore, the type of the collision object is the same as in (4) and (5) above, namely “guardrail.” Therefore, the collision occupant damage D2 becomes lower than that in (2) above, namely “2 points,” and the object damage D3 becomes lower than that in (1) above, namely “0 points.” Accordingly, the total damage Dt is 5 points.

Accordingly, since the total damage Dt becomes smallest when the deceleration control pattern B3 and the steering control pattern S2 are selected, the vehicle control is executed in accordance with the deceleration control pattern B3 and the steering control pattern S2.

When the server receives the control result information, the server learns a method for estimating the control occupant damage D1 based on the acceleration generated during the vehicle control and the posture change of the occupant during the vehicle control. Similarly, the server learns a method for estimating the collision occupant damage D2 based on the actual collision pattern and the posture change of the occupant at the time of collision. Furthermore, the server learns a method for estimating the object damage D3 based on the actual collision pattern and the actual damage to the collision object. The server transmits data relating to these learned methods to the present apparatus 10, and the present apparatus 10 estimates the control occupant damage D1, the collision occupant damage D2, and the object damage D3 using the received data.

(First Modified Example) For example, when priority is given to the safety of the occupant, the control occupant damage D1 and the collision occupant damage D2are regarded as more important than the object damage D3. In such a case, as one example, Ga1 and Ga2 are set to “1.0,” and Ga3 is set to “0.5.”

(Second Modified Example) In the above embodiment, both the deceleration control pattern and the steering control pattern are prepared in advance; however, either one of the deceleration control pattern or the steering control pattern may be prepared in advance.

The present apparatus 10 can be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). Furthermore, the present apparatus 10 can be applied not only to the vehicle (bus) shown in FIG. 1, but also to a passenger car and the like.

What is claimed is:

1. A vehicle control apparatus that, when a collision risk, which represents a risk of a vehicle colliding with an object, is equal to or greater than a threshold risk, performs vehicle control to change a traveling state of the vehicle according to a control pattern selected from among a plurality of control patterns so as to reduce the collision risk,
wherein the vehicle control apparatus is configured to:
estimate, for each of the control patterns,
a first occupant damage representing damage to an occupant caused by a change in the traveling state during a vehicle control period from when the vehicle control is executed according to the control pattern until the vehicle collides with a collision object,
a second occupant damage representing damage to the occupant at a collision time when the vehicle collides with the collision object as a result of executing the vehicle control according to the control pattern, and
an object damage representing damage to the collision object at the collision time; and
execute the vehicle control according to the control pattern that minimizes a total damage acquired based on the first occupant damage, the second occupant damage, and the object damage.

2. The vehicle control apparatus according to claim 1,
wherein the vehicle control apparatus is configured to:
estimate the first occupant damage based on an attribute of the occupant, a boarding state of the occupant, and an acceleration generated in the vehicle by the vehicle control executed according to the control pattern;
estimate the second occupant damage based on the attribute of the occupant, the boarding state of the occupant, an attribute of the collision object, and a collision pattern between the vehicle and the collision object; and
estimate the object damage based on the attribute of the collision object and the collision pattern.

3. The vehicle control apparatus according to claim 2,
wherein the vehicle control apparatus is configured to:
use an age and a gender of the occupant as the attribute of the occupant;
use a posture of the occupant, a gripping state of a structure in a passenger compartment of the vehicle by the occupant, a wearing state of an occupant restraint device of the occupant, a position of the occupant in the passenger compartment, and a congestion state in the passenger compartment as the boarding state;
use a type of the collision object as the attribute of the collision object; and
use a collision speed representing a speed of the collision object relative to the vehicle at the collision time, and a collision position representing a position on a vehicle body of the vehicle at which the collision object collides as the collision pattern.

4. The vehicle control apparatus according to claim 1,
wherein the control patterns include a plurality of deceleration control patterns for decelerating the vehicle and a plurality of steering control patterns for changing a traveling direction of the vehicle,
the plurality of deceleration control patterns having different decelerations from one another,
the plurality of steering control patterns having different lateral accelerations from one another, and
wherein the vehicle control apparatus is configured to select one deceleration control pattern from among the plurality of deceleration control patterns and one steering control pattern from among the plurality of steering control patterns.

5. The vehicle control apparatus according to claim 2,
wherein the vehicle control apparatus is configured to transmit, to a server outside of the vehicle, control result information capable of specifying an acceleration generated in the vehicle during execution of the vehicle control, a change in a posture of the occupant during execution of the vehicle control, an actual collision pattern, a change in the posture of the occupant at the collision time, and damage to the collision object;
wherein the server is configured to learn a method for estimating the first occupant damage, the second occupant damage, and the object damage based on the control result information; and
wherein the vehicle control apparatus is configured to acquire the first occupant damage, the second occupant damage, and the object damage using the method learned by the server.
